(19) United States
(12) Patent Application Publication
(10) Pub. No.: US 2009/0107222 A1
(43) Pub. Date: Apr. 30, 2009

(54) Scanning Probe Microscope with Improved Scanning Speed

(76) Inventors: Daniel Yves Abramovitch, Palo Alto, CA (US); David Patrick Fromm, Meno Park, CA (US); Dale Schroeder, Scotts Valley, CA (US)

Correspondence Address: AGILENT TECHNOLOGIES INC., INTELLECTUAL PROPERTY ADMINISTRATION,LEGAL DEPT., MS BLDG. E P.O. BOX 7599, LOVELAND, CO, 80537, US

(21) Appl. No.: 11/926,342

(22) Filed: Oct. 29, 2007

(51) Int. Cl. G01B 5/28

(52) U.S. Cl. 73/105

(57) ABSTRACT

A scanning probe microscope and method for using the same are disclosed. The scanning probe microscope includes a probe, an electro-mechanical actuator, and a controller. The probe has a tip that moves in response to an interaction between the tip and a local characteristic of a sample. The electro-mechanical actuator moves the sample relative to the probe tip in three dimensions. The controller maintains the probe tip in a fixed relationship with respect to the sample in one of the dimensions, and causes the electro-mechanical actuator to move the sample relative to the probe tip in the other two of the dimensions along a smooth path to generate an image of an object in the sample in an area sampled along the smooth path.

### BACKGROUND OF THE INVENTION

Scanning probe microscopes are a class of imaging techniques in which a tip that interacts locally with a sample is scanned over the surface of the sample to generate a three-dimensional image representing the properties of the surface. For example, in atomic force microscopy, the surface interaction force between the probe tip and the sample are measured at each point on the sample. The tip has a very small end and is mounted on the end of a cantilevered arm. As the tip is moved over the surface of the sample, the arm deflects in response to the changes in topology of the surface. Images are typically acquired in one of two modes. In the contact or constant force mode, the tip is brought into contact with the sample and the tip moves up and down as the tip is moved over the surface. The deflection of the arm is a direct measure of force and topographical variations. A feedback controller measures the deflection and adjusts the height of the probe tip so as to maintain constant force between the cantilevered probe and the surface, i.e., the arm at a fixed deflection.

In the AC, or non-contact mode, the tip and arm are oscillated at a frequency near the resonant frequency of the arm. The height of the tip can be controlled such that the tip avoids contact with the sample surface, sampling short-range tip/sample forces. Alterations in the oscillation frequency from short range forces between the tip and the sample result in changes in the oscillations of the tip. Alternatively, the tip can be allowed to make light intermittent contact with the sample only at the bottom of the oscillation cycle. Contact between the probe tip and the sample results in an alteration of the amplitude, phase and/or frequency of the oscillation. The controller adjusts the height of the probe over the sample such that the oscillation amplitude, phase and/or frequency is kept at a predetermined constant value. Since the tip is not in constant contact with the sample, the sheer forces applied to the sample are significantly less than in the mode in which the tip is in constant contact. For soft samples, this mode reduces the damage that the tip can inflict on the sample and also provides a more accurate image of the surface in its non-disturbed configuration.

In all of these modes, the image is constructed one point at a time and limited by the rate at which the tip can be moved relative to the sample, as well as the time required for the servo loop to reposition the tip vertically to maintain the distance between the surface and the tip. Hence, the time to acquire an entire image can be several minutes or longer, since the image acquisition process depends on mechanically moving the sample being scanned relative to the measurement probe. In one class of system, the probe is moved over the sample in a raster scanning pattern that zig-zags back and forth over the sample until the entire sample area has been measured. The acquisition time depends on the resolution desired in the image; at high resolutions, the total scanning time can be very long. Such long acquisition times are tolerable for stationary samples that do not change over the long sample acquisition time. However, the use of scanning probe microscopy on dynamic systems, as in the case of measuring transient events in biological samples is inhibited by excessive sampling time, since the phenomena of interest often occur in times that are small compared to the image acquisition time.

Hence, scanning schemes that reduce the total scanning time have been sought. In general, the image that is sought is one of an object that is within the field of view of the microscope but only occupies a small portion of that field of view. In one class of systems, a coarse scanning pattern is used to locate the object of interest. A fine raster scan is then performed over a limited area to measure the image of the object with as little of the uninteresting surrounding area being measured as possible. In the case of a linear molecule such as DNA, once the molecule is located, a scanning pattern that moves back and forth in a direction that approximates the linear dimensions of the molecule is utilized. Since the raster scan only operates over a small portion of the field of view, the image acquisition time is markedly reduced.

However, even when some form of coarse-fine scanning algorithm is utilized, the image acquisition time is still too long for many applications. In many imaging applications, the object of interest is moving or being altered in some manner over time scales that are on the order of the time needed to acquire an image using a raster scan algorithm. In addition, even when the acquisition time is acceptable, faster scanning times are preferred to minimize the time over which the microscope is devoted to each image. Accordingly, mechanisms for reducing the image acquisition time are still needed.

### SUMMARY OF THE INVENTION

The present invention includes a scanning probe microscope and method for using the same. The scanning probe microscope includes a probe, an electro-mechanical actuator, and a controller. The probe has a tip that moves in response to an interaction between the tip and a local characteristic of a sample. The electro-mechanical actuator moves the sample relative to the probe tip in three dimensions. The controller maintains the probe tip in a fixed relationship with respect to the sample in one of the dimensions, and causes the electro-mechanical actuator to move the sample relative to the probed tip in the other two of the dimensions along a smooth path to generate an image of an object in the sample in an area sampled along the smooth path. In one aspect of the invention, the smooth path includes an elliptical spiral. In another aspect of the invention, the controller moves the sample relative to the probe along a first smooth path to generate a first image of an object in the sample at a first resolution, and then the controller moves the sample relative to the probe along a second smooth path to generate a second image of the object at a second resolution that is greater than the first resolution. The second smooth path can be oriented in a manner determined by the first image. In another aspect of the invention, the controller causes the electro-mechanical actuator to move with a speed that varies as a function of position on the smooth path.

### BRIEF DESCRIPTION OF THE DRAWINGS

FIG. 1 illustrates a typical atomic force microscope that utilizes the scanning probe microscope of the present invention.

FIG. 2 illustrates one type of pattern that is used in scanning an object with a prior art scanning probe microscope.

FIG. 3 illustrates a scanning pattern that can be used to locate an object within the field of view of a scanning probe microscope.

FIG. 4 illustrates one embodiment of a fine spiral scan.

FIG. 5 illustrates a spiral scan path superimposed on a rectangular coordinate grid.

FIGS. 6A-6B illustrate other embodiments of a smooth scan path according to the present invention.

FIG. 7 illustrates an object scanned with a conventional raster scan in which the object moves over the course of the scan.

FIG. 8 illustrates the object shown in FIG. 7 being scanned using a spiral path according to the present invention.

FIGS. 9 and 10 illustrate a spiral scan along a path used to measure the object in the boundary area contained within the scan.

### DETAILED DESCRIPTION OF THE PREFERRED EMBODIMENTS OF THE INVENTION

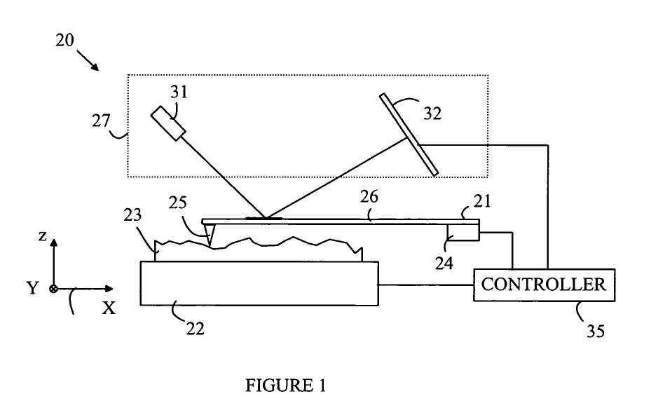

The manner in which the present invention provides its advantages can be more easily understood with reference to FIG. 1, which illustrates a typical atomic force microscope that utilizes the scanning probe microscope of the present invention. Microscope 20 includes a probe assembly 21 and a stage 22 on which a sample 23 to be imaged is mounted. A combination of actuators move the stage and probe relative to one another in three orthogonal directions. In the case of microscope 20, stage 22 moves the sample in an x-y plane under the probe assembly 21. Probe assembly 21 is attached to a second actuator 24 that moves probe assembly 21 in a z-direction that is perpendicular to the x-y plane. However, embodiments which use other mechanisms to move the probe relative to the sample with the required three degrees of freedom could also be utilized.

Probe assembly 21 includes a tip 25 that is mounted on an arm 26 that can deflect. The degree of deflection of arm 26 is measured by a detector 27. In the embodiment shown in FIG. 1, the detector 27 includes a light source 31 and photodetector 32. Light source 31 illuminates a reflector on arm 26, and the location of the reflected light is detected by photodetector 32. A servo loop is utilized by controller 35 to set the z-coordinate through actuator 24 such that the deflection of arm 26 is maintained at a predetermined value. The z-coordinate of the probe tip relative to the sample as a function of the (x,y) position of the stage provides a three-dimensional topological map of the sample surface. The range of motion in the x-y plane sets the maximum field of view of the microscope. In general, the object of interest in the field of view accounts for a relatively small portion of the field of view of the microscope.

To improve the rate at which the interesting parts of the field of view of the microscope are scanned, the highest resolution scanning should be concentrated in the regions of likely interest and the average number of useful sample points measured per unit time within the region of interest should be maximized. The number of useful sample points that can be taken per unit time depends on the speed with which the probe can be moved over the sample surface and any dead time that must be inserted into the sampling pattern to allow the probe to settle after an abrupt change in motion of the sample relative to the probe.

The maximum speed with which a scanning probe can be moved over the surface of a sample depends on the properties of the probe and the forces applied to the probe from sources other than the probe-sample interaction on which the image is based. The probes, in general, have resonant frequencies that can be excited by forces being applied to the probe because of the interaction with the moving surface coupling in the Z-direction. Consider the case in which the stage on which the sample rides accelerates or decelerates while the probe is interacting with the sample surface. In general, the probe will also be subjected to a change in force that is related to changes in this acceleration or deceleration. These additional forces cannot be easily distinguished from forces arising from the desired interaction of the probe and the sample, and hence, can cause errors in the measured images. In addition, changes in direction of the stage, which has a significant mass, can result in vibrations being propagated through the mechanical connections in the microscope. These vibrations can also excite the resonances in the probe assembly. To avoid these errors, the probe must be allowed to settle after an abrupt change in direction or other varying acceleration or deceleration event.

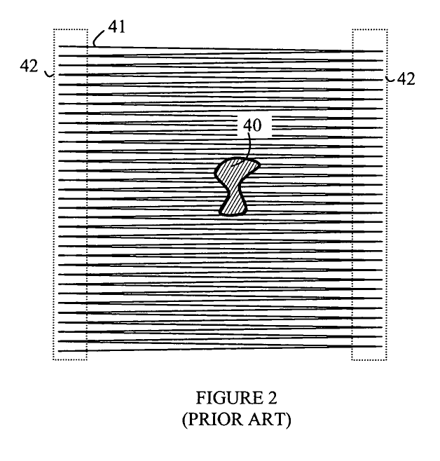

Refer now to FIG. 2, which illustrates one type of pattern that is used in scanning an object 40 with a prior art scanning probe microscope. The pattern is essentially a continuous raster scan in which the probe moves along a ziz-zag path 41. Each time the stage changes directions at the end of a scan line in the regions shown at 42, the sample is subjected to a time-variant deceleration followed by a time-variant acceleration. Hence, any data taken near the ends of a scan line is subject to errors resulting from the forces applied during the change in motion. Accordingly, the region that must be scanned to assure that all points within the region of interest have acceptable errors must be larger than the region of interest to provide a region for the probe to change directions. Furthermore, data that lacks these effects cannot be generated until any oscillations induced in the probe by these applied forces have had time to dissipate. Hence, the average number of useful samples that can be scanned in any given time period is limited by this settling time and the need to provide turnaround regions at the end of the scan lines.

The present invention is based on the observation that the rate at which useful sample points can be measured can be increased by utilizing a scanning path pattern that does not subject the stage to changes in accelerations and decelerations that in turn subject the probe to a force that varies by more than a predetermined value. Such a path substantially reduces the time needed to allow the probe to settle and the above-described dead zones at the scan points at which the probe reverses directions in the prior art raster scanning processes.

For the purposes of the present discussion, a “smooth path” will be defined to be any continuous path that samples a two-dimensional region of the field of view of the microscope with sufficient accuracy to generate an image of that region and in which the forces generated by variation in accelerations and decelerations of the probe relative to the sample are sufficiently small that errors resulting from such forces do not substantially alter the quality of the image, and hence, sample measurements can be taken continuously at each point along the path. In general, a smooth path will include a trajectory that defines the position of the probe in the x-y plane relative to the sample and the speed of the probe over that path as a function of position along the path.

In one embodiment of the present invention, the scan path is constructed from spiral scan paths in which the shortest radius of curvature is selected such that the centrifugal forces of the stage, and any mechanical vibrations resulting from the change in direction of the stage over the path that are applied to the probe, do not change by more than a predetermined amount from point to point. By limiting the rate of change of the forces from the probe x-y motion, these changes in force are prevented from interfering significantly with the sample measurements. In addition, a coarse-fine scanning algorithm can be used to limit the amount of time the apparatus spends measuring points within the field of view that do not contain any objects of interest.

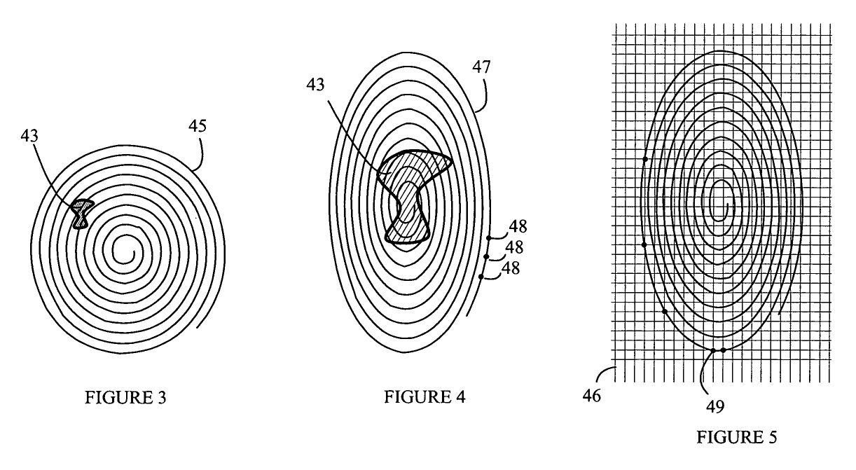

Refer now to FIG. 3, which illustrates a scanning pattern 45 that can be used to locate an object 43 within the field of view of a scanning probe microscope. Scan pattern 45 is a circular spiral pattern in which the center spiral is limited to a path with a predetermined minimum radius of curvature such that changes in the centrifugal force are kept to an acceptable value. A circular spiral path is utilized because it is assumed that the shape and orientation of the object of interest is not known. The distance between the loops of the spiral is set to a constant value that is less than the minimum size of an object of interest.

It should be noted that the speed of the stage could also be varied in the central regions of the pattern to reduce the forces in that region and increased in the regions in which the radius of curvature of the path is larger. Since the purpose of the coarse scan is to locate objects of interest, the acceptable limits on the rate of change of the stage motion generated forces are somewhat higher because the accurate data will not start until the fine scan region has been determined. Hence, the smooth path utilized in the coarse scanning operation could be characterized by a higher error limit than the smooth path used to image the object once the region of interest has been defined.

Once an object of interest has been located in the coarse scan, a new scan pattern is initiated to provide a higher resolution scan of the object of interest. Refer now to FIG. 4, which illustrates one embodiment of a fine spiral scan 47. If the coarse scan has sufficient resolution, an estimate of the spatial extent and orientation of object 43 can be generated. The fine scan pattern in this case is an elliptical spiral. The spacings of the successive loops of the spiral are set by the spatial resolution that is required for the image of object 43.

The orientation of the spiral and the ratio of the major and minor axes of the ellipses can be adjusted based on the coarse scan data. In the coarse scan, the object can be approximated by a rectangle in which the relative lengths of the sides of the rectangle and the orientation of the rectangle relative to a predetermined set of axes in the scanning plane are fit to the data. The ratio of the major axes to the minor axes of the ellipses in the spiral is set to be approximately the same as the ratio of the long side of the rectangle to the short side of the rectangle. The orientation of the major axes of the ellipses relative to one of the axes in the scanning plane is set to be approximately that of the long side of the rectangle to that axis. The spiral pattern is centered on the center of the fitted rectangle.

The data points could be recorded at fixed distances along the spiral path. Exemplary fixed measurement points are shown at 48. Alternatively, the samples could be measured when the spiral path crosses the intersection points on a predetermined rectangular grid 46 as shown in FIG. 5 which illustrates a spiral scan path superimposed on a rectangular coordinate grid. An exemplary measurement point in which the scan path crosses the intersection of a vertical and horizontal grid line is shown at 49. In yet another embodiment, measurements could be made at each point that the scan path crosses either a horizontal or vertical grid line. In all of these cases, the data points will not necessarily be taken at regular distances along the grid lines, and hence, the resultant data set will not be uniformly sampled in the x-y plane.

In one embodiment of the present invention, controller 35 resamples the data mathematically to provide measurements on the fixed grid so that the data can be more easily displayed as a conventional image. The resampling can provide an image that is a conventional (x,y,z) pixel representation of the object. Alternatively, the resampling can provide a topological map of the object in which points having the same z value are joined to provide the contours of the object at various heights in the object.

The above-described embodiments of the present invention utilize a scan path that has a spiral topology. That is, the path consists of a number of linked loops in which the loops do not cross one another and each loop is contained within another loop with the exception of the outermost loop. Since the average radius of curvature of the path increases with distance from the center of the spiral, the stage motion-related forces between the probe and the sample change over the path, and hence, could restrict the speed at which the stage can be moved in the central region of the path. However, other scan paths that avoid sharp turns and have more constant stage motion related forces could be utilized.

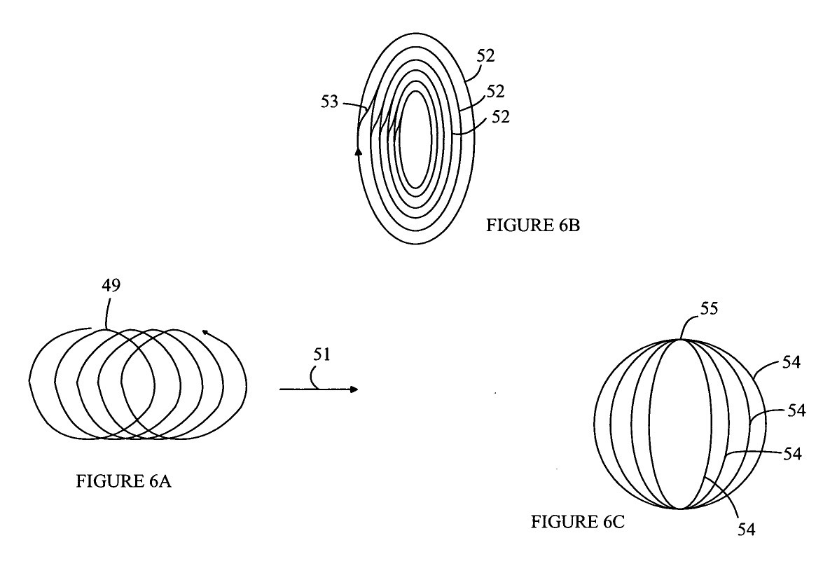

Refer now to FIGS. 6A-6C, which illustrate three other embodiments of a smooth scan path according to the present invention. Referring to FIG. 6A, scan path 49 is a set of linked elliptical loops in which each loop is transposed by a finite distance from the previous loop along a path 51. In one embodiment, direction 51 is chosen to coincide with an axis of the object being scanned in a manner analogous to that described above. In another embodiment, the loops are substantially circular.

FIGS. 6A and 6B illustrate scan paths constructed from a plurality of nested loops. FIG. 6B illustrates a scan path constructed from a set of concentric ellipses 52 in which the scan path traverses each ellipse in a clockwise direction from the outside most ellipse and then transitions to the adjacent path along a smooth connecting path 53. FIG. 6C illustrates a scan path constructed from a nested series of ellipses 54 in which each ellipse has the same major axis, and the transition from one ellipse to another is made at a point 55 in which all of the ellipses are joined to one another. While all of these examples utilize ellipse shaped loops, other forms of smooth loops could also be utilized in place of the ellipses.

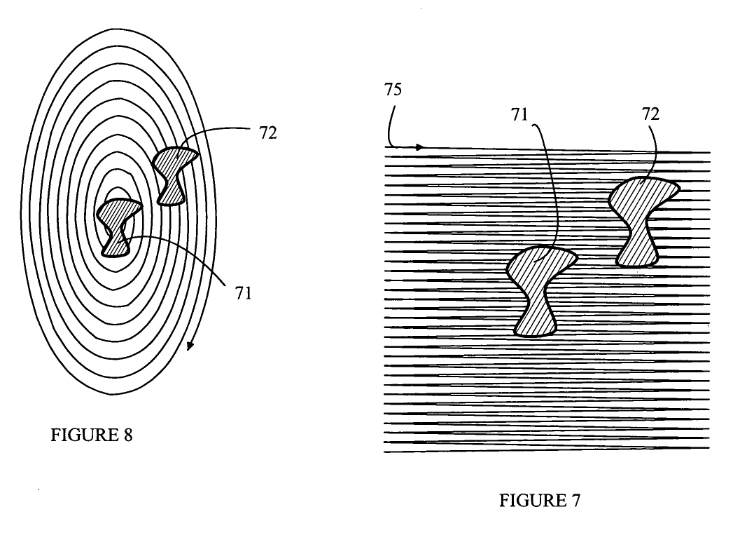

The spiral scan paths described above are particularly well suited to imaging objects that move during the course of the scan. Consider an object that is located in a coarse scan and is moving at a rate that causes the object to be displaced from its original position during the fine scan. Refer now to FIG. 7, which illustrates an object scanned with a conventional raster scan in which the object moves over the course of the scan. It is assumed that the object was originally located during a coarse scan and that a raster scan path 75 was laid out to provide a fine resolution map of the object. The object was at location 71 at the beginning of the scan and moves to location 72 by the end of the scan. Once the scan passes the object, no more information about the object's position or speed can be obtained. Hence, the proper position on which to center the next scan cannot always be obtained. In particular, if the object moves toward the beginning of the scan as show in FIG. 7, the object will only be scanned once during the raster, and hence, the objects speed and direction cannot be obtained.

Refer now to FIG. 8, which illustrates the same object being scanned using a spiral path according to the present invention. Since the beginning of the spiral scan is centered on the object, the object will always be encountered in subsequent loops of the scan as the spiral moves outwards. Hence, multiple scans of the entire object can be obtained independent of the direction in which the object is traveling. If two measurements of the same point on the object are obtained, the direction and speed of the object can be computed. Hence, controller 35 can center the next scan at the projected location of the object and avoid making another coarse scan.

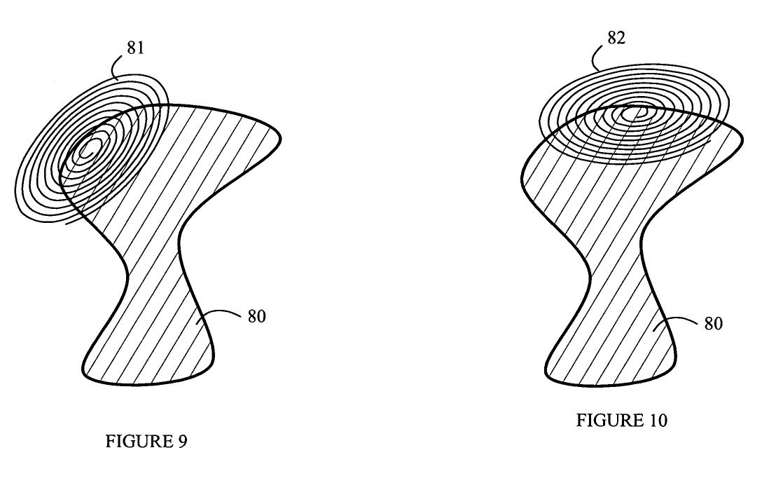

The above-described embodiments of the present invention assume that the object is located in a first scan and then completely scanned in the higher resolution mode in a second scan using a smooth path according to the present invention. However, embodiments in which the object is scanned using a number of high-resolution scans can also be utilized. For example, in an application in which the boundary of an object is of particular interest, a number of high resolution spiral scans could be taken centered at different points along the boundary. An estimate of the location of the boundary could be provided by the lower resolution scan that identified the object or from a previous high resolution scan. Refer now to FIGS. 9 and 10, which illustrate a scanning algorithm in which a number of high-resolution scans are utilized to characterize an object. It is assumed that object 80 has been located in a previous coarse scan. Referring to FIG. 9, a first spiral scan along path 81 is used to measure the object in the boundary area contained within the scan. The next high resolution scan can be defined from the data obtained in the first spiral scan and/or from the data from the initial coarse scan. The data is then fit to a model of the boundary to determine the next point and orientation at which another scan should be centered to provide data on the next region of the object. A second spiral scan 82 is then used to collect data at the next region, and so on.

In the above-described embodiments, the distance between the turns of the spiral paths or linked loops was substantially constant. However, embodiments in which the distance between the loops changes as a function of distance along the path can also be constructed. For example, in the case of a spiral scan path, the distance between the loops could be increased at distances from the center of the path determined by the results of the scans in the previous loops of the spiral. Such an algorithm could be used to scan the area immediately around an object that has already been scanned at the high resolution to determine if there are any other small objects in the region of the larger object. If another object is detected, a new spiral scan in the region of that object could then be initiated. Various modifications to the present invention will become apparent to those skilled in the art from the foregoing description and accompanying drawings. Accordingly, the present invention is to be limited solely by the scope of the following claims.

What is claimed is:

1. A scanning probe microscope comprising:
a probe having a tip that moves in response to an interaction between said tip and a local characteristic of a sample;
an electro-mechanical actuator for moving said sample relative to said probe tip in three dimensions; and
a controller for maintaining said probe tip in a fixed relationship with respect to said sample in one of said dimensions, said controller causing said electro-mechanical actuator to move said sample relative to said probe tip in said other two of said dimensions along a smooth path to generate an image of an object in said sample in an area sampled along said smooth path.

2. The scanning probe microscope of claim 1 wherein said smooth path comprises an elliptical spiral.

3. The scanning probe microscope of claim 1 wherein said smooth path comprises a plurality of linked loops having centers on a predetermined path.

4. The scanning probe microscope of claim 1 wherein said smooth path comprises a plurality of nested smooth closed curves joined by smooth paths connecting said smooth closed curves.

5. The scanning probe microscope of claim 4 wherein said smooth closed curves comprise elliptical loops.

6. The scanning probe microscope of claim 4 wherein said smooth closed curves comprises concentric smooth curves.

7. The scanning probe microscope of claim 1 wherein said controller moves said sample relative to said probe along a first smooth path to generate a first image of an object in said sample at a first resolution and then said controller moves said sample relative to said probe along a second smooth path to generate a second image of said object at a second resolution that is greater than said first resolution.

8. The scanning probe microscope of claim 7 wherein said second smooth path is oriented in a manner determined by said first image.

9. The scanning probe microscope of claim 8 wherein said second smooth path is an elliptical spiral having an orientation and dimensions determined by said object in said first image.

10. The scanning probe microscope of claim 1 wherein said controller causes said electro-mechanical actuator to move with a speed that varies as a function of position on said smooth path.

11. A method of operating a scanning probe microscope comprising:
providing a probe having a tip that moves in response to an interaction between said tip and a local characteristic of a sample;
moving said sample relative to said probe tip in one dimension to maintain a predetermined relationship between said probe and said sample; and
moving said sample relative to said probe in two-dimensions orthogonal to said one dimension along a smooth path to generate an image of an object in said sample in an area sampled along said smooth path.

12. The method of claim 11 wherein said smooth path comprises an elliptical spiral.

13. The method of claim 11 wherein said smooth path comprises a plurality of linked loops having centers on a predetermined path.

14. The method of claim 11 wherein said smooth path comprises a plurality of linked loops having centers on a predetermined path.

15. The method of claim 11 wherein said smooth path comprises a plurality of nested smooth closed curves joined by smooth paths connecting said smooth closed curves.

16. The method of claim 15 wherein said smooth closed curves comprises concentric smooth curves.

17. The method of claim 11 comprising moving said probe along a first smooth path to generate a first image of an object in said sample at a first resolution and then moving said sample relative to said probe along a second smooth path to generate a second image of said object at a second resolution that is greater than said first resolution.

18. The method of claim 17 wherein said second smooth path is oriented in a manner determined by said first image.

19. The method of claim 18 wherein said second smooth path is an elliptical spiral having an orientation and dimensions determined by said object in said first image.

20. The method of claim 11 wherein said sample is moved relative to said probe with a speed that varies as a function of position on said smooth path.
